(19) United States
(12) Patent Application Publication
(10) Pub. No.: US 2025/0179394 A1
(43) Pub. Date: Jun. 5, 2025

(54) MULTILAYER SYSTEM COMPRISING COMPOSITIONS HAVING SPECIFIC PERFUME COMPOSITIONS

(71) Applicant: HENKEL AG & CO. KGAA, Düsseldorf (DE)

(72) Inventors: Frank PESSEL, Düsseldorf (DE); Andreas BAUER, Kaarst (DE); Elke Maria MUENZEL, Krefeld (DE)

(21) Appl. No.: 18/843,259

(22) PCT Filed: Feb. 23, 2023
(86) PCT No.: PCT/EP2023/054609

§ 371 Date: Sep. 1, 2024

(30) Foreign Application Priority Data
Mar. 4, 2022 (DE) 10 2022 105 170.6

(51) Int. Cl. C11D 3/50; C11D 17/00

(52) U.S. Cl. CPC C11D 3/50; C11D 17/0056

(57) ABSTRACT

A multilayer system including a first layer and a second layer is described. Each of the first layer and the second layer includes a composition having at least one specific perfume composition. A cleaner or an air freshener including the multilayer system is described. A method for fragrancing a toilet using the multilayer system is described. A method for producing the multilayer system is also described.

The invention relates to a multilayer system comprising (a) a first layer and (b) a second layer, each layer comprising or consisting of a composition having at least one specific perfume composition. The invention also relates to a means comprising the multilayer system according to the invention. The invention further relates to a method for fragrancing a toilet, wherein a multilayer system according to the invention is used in at least one method step. Furthermore, a method for producing the multilayer system according to the invention and the use of the multilayer system according to the invention for fragrancing a toilet are aspects of the invention.

NECA (non-electric continuous action) air fresheners or liquid, gel or solid active ingredient preparations for the toilet are formulated with high proportions of perfume oil in order to spread freshness in the room or to act against bad odors. These air fresheners or toilet additives are typically formulated with a single perfume composition. Depending on the application, air fresheners or toilet additives, or their perfume compositions are mostly formulated such that, over weeks after activation, they should always provide the same intensity and the same olfactory impression.

Both NECAs and other technical systems are equipped in such a way that a complete “perfume composition” consisting of top, middle and base notes to be released into the room is always released and discerned. The FMCG market (fast-moving consumer goods) demonstrates the need for products which never have the same smell, i.e., products which are always different and smell new, without a habituation effect occurring, as is the case with conventional room fragrances.

The individual constituents of a conventionally composed perfume volatilize at different rates. The time it takes for the perfume fragrance to be discerned is referred to as the development. The development is subdivided into scent notes which usually merge fluidly into one another. A distinction is made between three scent notes: top note, middle note, and base note. Perfumes usually contain all three notes. The top note of a perfume is responsible for the “first impression” that a perfume conveys. The top note typically consists of intensive, light, highly volatile fragrances having a maximum period of discernment of several minutes. The middle note is the scent that can be discerned when the top notes have evaporated. The middle note of a perfume is responsible for the actual fragrance character of a perfume. The middle note consists of fragrances having a maximum discernment period of several hours. The base note is the fragrance that is the last to be discerned. It typically contains long-lasting, heavy fragrances which can endure for days.

Due to high variances in the processing of ceramic materials, toilets have very diverse water flush behaviors. Nevertheless, washing around and over the toilet additives with flush water typically causes the additives to demonstrate an olfactory delta, i.e., a discernment lift in the intensity of the fragrancing. This is due to the rinsing away or dissolution of the soap-like or gel-like active ingredient preparation, in which form these toilet additives are typically formulated, or due to the turbulence and air movements generated by the flush water in the toilet. Conventionally, these perfumes are typically composed as is the case for NECA air fresheners. In this case, fragrances are used which are released into the ambient air well to very well at room temperature.

It has now surprisingly been found that systems consisting of two or more layers, wherein preferably each layer contains a different perfume composition, preferably air fresheners or toilet additives, in particular liquid or gel toilet rimblocks, repeatedly create a new and/or changing fragrance experience. The individual layers are preferably liquid or gel. In particular when flush water is released in a toilet and due to the consumptive rinsing of the (gel) layers when the toilet is used, an olfactory delta is produced, i.e., the discernment of the intensity and of the fragrance impression/fragrance development which is achieved over the entire life cycle of the toilet additive changes once or several times over the period of use. This change is also referred to in the context of this invention as discernment lift.

Thus, according to a first aspect, the invention relates to a multilayer system comprising:
(a) a first layer comprising or consisting of a composition having at least one perfume composition, wherein the perfume composition comprises
   (i) at least one fragrance having a vapor pressure at 25° C.>0.0133 kPa and a ClogP≤2.5; and
   (ii) at least one fragrance having a vapor pressure at 25° C.<0.000133 kPa and a ClogP≥4.0;
(b) a second layer comprising or consisting of a composition having at least one perfume composition, wherein the perfume composition comprises
   (i) at least one fragrance having a vapor pressure at 25° C.>0.0133 kPa and a ClogP≤2.5; and
   (ii) at least one fragrance having a vapor pressure at 25° C.<0.000133 kPa and a ClogP≥4.0.

In a particularly preferred embodiment, the multilayer system comprises
(a) a first layer comprising or consisting of a composition having at least one perfume composition, wherein the perfume composition comprises
   (i) 0.01 wt. % to 30 wt. % of at least one fragrance having a vapor pressure at 25° C.>0.0133 kPa and a ClogP≤2.5; and
   (ii) less than 15 wt. % of at least one fragrance having a vapor pressure at 25° C.<0.000133 kPa and a ClogP≥4.0;
(b) a second layer comprising or consisting of a composition having at least one perfume composition, wherein the perfume composition comprises
   (i) 0.01 wt. % to 20 wt. % of at least one fragrance having a vapor pressure at 25° C.>0.0133 kPa and a ClogP≤2.5; and
   (ii) more than 55 wt. % of at least one fragrance having a vapor pressure at 25° C.<0.000133 kPa and a ClogP≥4.0.

Particularly preferably, the first layer and/or the second layer of the multilayer system are liquid or gel at room temperature (20° C.; and at standard pressure (1 bar)). In various embodiments, the first and the second layer are directly adjacent, i.e., they are adjoin one another with at least one surface. The first layer is usually below or above the second layer. In various embodiments of the invention, the layers are water soluble or water dispersible, i.e., they dissolve or the constituents are dispersed upon contact with water. This property relates to the behavior at standard conditions, i.e., at room temperature (20° C.) and normal pressure (1 bar). In various embodiments, the first and second and optionally also each further layer are arranged in such a way that they only come into contact with the surroundings, and here in particular water, one after the other. This typically occurs in such a way that the layers are arranged one above the other in a container, so that only the uppermost layer ever comes into contact with the surroundings, for example with the ambient air or flush water, and only when the uppermost layer has gradually dissolved or been dispersed or dissipated in the flush water does the next layer thereunder come into contact with the surroundings, typically with the flush water. A changed fragrance impression can therefore be brought about by this successive dissolution of the different layers that are one on top of the other. The altered fragrance impression is brought about by the various perfume compositions contained in the respective layers.

In a further aspect, the invention relates to a means comprising the multilayer system according to the invention. The multilayer system can also be such a means. Examples of such means are toilet cleaners or toilet rim blocks, in particular those in gel form.

A further aspect of the invention is a method for fragrancing a toilet, wherein the multilayer system according to the invention or the means according to the invention is used in at least one method step. In this case, it is particularly preferred that the fragrance impression change over time.

In a further aspect, the invention relates to a method for producing the multilayer system according to the invention. Preferably, the compositions of the first layer and/or of the second layer are melted at at least 50° C. and then poured into the layer mold.

In a last aspect, the invention relates to the use of the multilayer system according to the invention or of the agent according to the invention for fragrancing a toilet, wherein the fragrance impression preferably changes over time.

These and other aspects, features and advantages of the invention will become apparent to a person skilled in the art through the study of the following detailed description and claims. Any feature from one aspect of the invention can be used in any other aspect of the invention. Furthermore, it will readily be understood that the examples contained herein are intended to describe and illustrate but not to limit the invention and that, in particular, the invention is not limited to these examples.

Unless indicated otherwise, all percentages are indicated in terms of wt. %. Numeric ranges specified in the format “from x to y” include the specified values. If several preferred numerical ranges are specified in this format, it is readily understood that any ranges resulting from the combination of the various endpoints are also included.

Numerical values specified herein without decimal places refer in each case to the full specified value with one decimal place. For example, “99%” stands for “99.0%”.

“At least one” as used herein includes, but is not limited to, 1, 2, 3, 4, 5, 6, and more. In relation to an ingredient, it refers to the type of ingredient and not to the absolute number of molecules. “At least one fragrance” thus means, for example, at least one type of fragrance, i.e., that one type of fragrance or a mixture of several different fragrances may be meant. Together with weight specifications, the expression relates to all compounds of the type indicated that are contained in the composition/mixture; i.e., the composition does not contain any other compounds of this type beyond the indicated amount of the corresponding compounds.

According to the invention, the multilayer system described in more detail below is characterized in that it comprises at least a first and a second layer, wherein
(a) the first layer comprises or consists of a composition having at least one perfume composition, wherein the perfume composition comprises
   (i) at least one fragrance having a vapor pressure at 25° C.>0.0133 kPa and a ClogP≤2.5; and
   (ii) at least one fragrance having a vapor pressure at 25° C.<0.000133 kPa and a ClogP≥4.0;
(b) the second layer comprises or consists of a composition having at least one perfume composition, wherein the perfume composition comprises
   (i) at least one fragrance having a vapor pressure at 25° C.>0.0133 kPa and a ClogP≤2.5; and
   (ii) at least one fragrance having a vapor pressure at 25° C.<0.000133 kPa and a ClogP≥4.0.

In various embodiments, the perfume composition of the first layer and that of the second layer differ, preferably differ in such a way that they cause a distinguishably different scent impression.

In the context of the present invention, the term “perfume composition” refers to mixtures of two or more fragrance compounds, and thus includes, for example, synthetic products of the ester, ether, aldehyde, ketone, alcohol, and hydrocarbon type, as well as natural fragrance mixtures, such as those accessible from plant sources.

The odor of a scent/fragrance is perceived as pleasant by most people, and frequently corresponds to the odor of, for example, flowers, fruits, spices, bark, resin, leaves, grasses, mosses and roots. Thus, scents/fragrances can also be used to mask unpleasant odors or to provide an odor-free substance with a desired odor.

The structure of perfume compositions is typically described, as classified below (see also international patent application WO 2016/200761 A2):
Top note: Vapor pressure at 25° C.:>0.0133 kPa
Middle note: Vapor pressure at 25° C.: 0.0133-0.000133 kPa
Top note: Vapor pressure at 25° C.:<0.0133 kPa.

The vapor pressure is determined, for example, by means of the commercially available program EPI Suite 4.11 (MPBPWIN v 1.43 (modified grain method). Unless stated otherwise, the values mentioned herein were calculated using this program.

In addition, however, it has been found that the ClogP value of the fragrances, which is a measure of the hydrophilicity of a compound, is a decisive factor in the discernment of the fragrance, since certain fragrances are rinsed away at different rates as a function of the ClogP value and the multisensory effect is thus intensified further. For example, fragrances with ClogP values less than or equal to 2.5 are rinsed away more quickly and distributed better in a room than, for example, fragrances having a ClogP greater than or equal to 4. The ClogP value is the n-octanol water distribution coefficient of a chemical compound and can be calculated for each chemical compound. Suitable programs for carrying out such a calculation or lists with corresponding ClogP values are known in the prior art and are readily available to a person skilled in the art. A suitable program is, for example, EPI Suite 4.11 (KOWWIN v 1.68). Unless stated otherwise, the values mentioned herein were calculated using this program.

In preferred embodiments, the perfume compositions of the first layer and the second layer differ. The difference can be found, for example, in the fragrances used, or identical or similar fragrances are used, but are used in different amounts in the perfume composition. However, it is also possible for the perfume compositions to contain both other fragrances and other concentrations of fragrances. However, it would also be conceivable for the compositions to contain the same basic perfume composition, but for further fragrances or scent enhancers, which change the fragrance experience, to be added to a layer.

In preferred embodiments,
(i) the at least one fragrance having a vapor pressure at 25° C.>0.0133 kPa and a ClogP≤2.5 in an amount of 0.001 to 70 wt. %, preferably 0.05 to 60 wt. %, more preferably 0.01 to 50 wt. %, for example 0.01 to 30 wt. %, 0.1 to 20 wt. % or 1 to 40 wt. %, is contained in the at least one perfume composition of the first layer; and/or
(ii) the at least one fragrance having a vapor pressure at 25° C.<0.000133 kPa and a ClogP≥4.0 in an amount of less than 30 wt. %, preferably less than 25 wt. %, more preferably less than 20 wt. %, for example less than 15 wt. %, less than 10 wt. % or less than 5 wt. %, is contained in the at least one perfume composition of the first layer; and/or
(iii) the at least one fragrance having a vapor pressure at 25° C.>0.0133 kPa and a ClogP≤2.5 in an amount of 0.001 to 40 wt. %, preferably 0.05 to 30 wt. %, more preferably 0.02 to 30 wt. %, even more preferably 0.01 to 20 wt. %, for example 0.01 to 10 wt. %, 0.1 to 15 wt. %, or 1 to 20 wt. %, is contained in the at least one perfume composition of the second layer; and/or
(iv) the at least one fragrance having a vapor pressure at 25° C. of 0.000133 kPa and a ClogP≥4.0 in an amount of more than 30 wt. %, preferably more than 35 wt. %, more preferably more than 40 wt. %, even more preferably more than 50 wt. %, for example 30 to 50 wt. %, 35 to 60 wt. %, or 32 to 55 wt. %, is contained in the at least one perfume composition of the second layer;
   wherein the quantitative data are based in each case on the total weight of the respective perfume composition.

A particularly preferred embodiment is a multilayer system comprising
(a) a first layer comprising or consisting of a composition having at least one perfume composition, wherein the perfume composition comprises
   (i) 0.01 wt. % to 50 wt. % of at least one fragrance having a vapor pressure at 25° C.>0.0133 kPa and a ClogP≤2.5; and
   (ii) less than 20 wt. % of at least one fragrance having a vapor pressure at 25° C.<0.000133 kPa and a ClogP≥4.0;
(b) a second layer comprising or consisting of a composition having at least one perfume composition, wherein the perfume composition comprises
   (i) 0.01 wt. % to 20 wt. % of at least one fragrance having a vapor pressure at 25° C.>0.0133 kPa and a ClogP≤2.5; and
   (ii) more than 30 wt. % of at least one fragrance having a vapor pressure at 25° C.<0.000133 kPa and a ClogP≥4.0.

In various embodiments, the fragrance (i) of the first layer has a vapor pressure at 25° C.>0.05 kPa, for example >0.1 kPa, >0.5 kPa, >1 kPa or >10 kPa. In various embodiments, the ClogP is ≤2.0, for example ≤1.5, ≤1 or ≤0.5. In various embodiments, the fragrance (ii) of the first layer has a vapor pressure at 25° C.<0.00001 kPa, for example <0.000001 kPa. In various embodiments, the ClogP is >4.5, for example ≥5. In various embodiments, the fragrance (i) of the second layer has a vapor pressure at 25° C.>0.05 kPa, for example >0.1 kPa, >0.5 kPa, >1 kPa or >10 kPa. In various embodiments, the ClogP is ≤2.0, for example ≤1.5, ≤1 or ≤0.5. In various embodiments, the fragrance (ii) of the second layer has a vapor pressure at 25° C.<0.00001 kPa, for example <0.000001 kPa. In various embodiments, the ClogP is ≥4.5, for example ≥5.

In preferred embodiments, the multilayer system is a liquid/gel multilayer system. In particular, the individual layers can be present as homogeneous solutions or suspensions.

“Liquid,” as used herein, includes liquids and gels as well as pasty compositions. It is preferred that the liquid compositions are flowable and pourable at room temperature, but it is also possible for them to have a limit of liquidity. It is particularly preferred that the first and/or second layer are liquid or gel. Both the first layer and the second layer are preferably liquid or gel. All layers of the multilayer system are particularly preferably liquid or gel, i.e., are in particular all liquid or all gel, wherein they preferably have substantially the same viscosities and flow properties. However, the layers should preferably have a consistency which prevents mixing of the layers during production, storage, use or application. Even if not preferred, however, it is not ruled out that at least one layer is solid at room temperature.

In various embodiments, the first layer is first filled into a container in the multilayer system and then the second layer is provided on top thereof. In other embodiments, the arrangement of the layers is precisely the other way round. The composition for the second layer is then first added to a container, and the composition of the first layer is then added on top thereof.

It is further preferred that the at least one perfume composition of the first layer and/or the perfume composition of the second layer comprise at least one further fragrance having a vapor pressure at 25° C. of 0.0133 to 0.000133 kPa. In various embodiments, such a further fragrance can have a ClogP value in the range 2 to 4. In particularly preferred embodiments, both the first layer and the second layer comprise such a further fragrance.

At least one fragrance of the multilayer system according to the invention may be, for example, an aldehyde, preferably selected from adoxal (2,6, 10-trimethyl-9-undecenal), anisaldehyde (4-methoxybenzaldehyde), cymal (3-(4-isopropyl-phenyl)-2-methylpropanal), ethyl vanillin, Florhydral (3-(3-isopropylphenyl) butanal), helional (3-(3,4-methylenedioxyphenyl)-2-methylpropanal), heliotropin, hydroxycitronellal, lauraldehyde, Lyral (3-and 4-(4-hydroxy-4-methylpentyl)-3-cyclohexene-1-carboxaldehyde), methyl nonyl acetaldehyde, Lilial (3-(4-tert-butylphenyl)-2-methylpropanal), phenylacetaldehyde, undecylenic aldehyde, vanillin, 2,6,10-trimethyl-9-undecenal, 3-dodecen-1-al, alpha-n-amyl cinnamaldehyde, melonal (2,6-dimethyl-5-heptenal), 2,4-di-methyl-3-cyclohexene-1-carboxaldehyde (Triplal), 4-methoxybenzaldehyde, benzaldehyde, 3-(4-tert-butylphenyl)-propanal, 2-methyl-3-(para-methoxyphenyl) propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl) propanal, 1-decanal, 2,6-dimethyl-5-heptenal, 4-(tricyclo [5.2.1.0(2,6)]-decylidene-8)-butanal, octahydro-4,7-methane-1H-indenecarboxaldehyde, 3-ethoxy-4-hydroxybenzaldehyde, para-ethyl-alpha, alpha-dimethyl hydrocinnamaldehyde, alpha-methyl-3,4-(methylenedioxy)-hydrocinnamaldehyde, 3,4-methylenedioxybenzaldehyde, alpha-n-hexylcinnamaldehyde, m-cymen-7-carboxaldehyde, alpha-methylphenylacetaldehyde, 7-hydroxy-3,7-dimethyloctanal, undecenal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methane indane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyl-octanal, trans-4-decenal, 2,6-nonadienal, para-tolyl acetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methane indane-1-carboxaldehyde, 2-methyloctanal, alpha-methyl-4-(1-methylethyl)benzeneacetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-Propyl-bicyclo-[2.2.1]-hept-5-ene-2-carbaldehyde, 9-decenal, 3-methyl-5-phenyl-1-pentanal, methylnonylacetaldehyde, hexanal and/or trans-2-hexenal. Mixtures of said substances may also be used.

In various embodiments, at least one fragrance of the multilayer system according to the invention may be a ketone, preferably selected from methyl-beta-naphthyl ketone, musk indanone (1,2,3,5,6,7-hexahydro-1, 1,2,3,3-pentamethyl-4H-inden-4-one), tonalide (6-acetyl-1,1,2,4,4,7-hexamethyltetralin), alpha-damascone, beta-damascone, delta-damascone, iso-damascone, damascenone, methyl dihydrojasmonate, menthone, carvone, camphor, Koavone (3,4,5,6,6-pentamethylhept-3-en-2-one), fenchone, alpha-ionone, beta-ionone, gamma-methyl-ionone, fleuramone (2-heptylcyclopentanone), dihydrojasmone, cis-jasmone, Iso-E-Super (1-(1,2,3,4,5,6J,8-octahydro-2,3,8,8-tetramethyl-2-naphthalenyl)-ethane-1-one (and isomers)), methyl cedrenyl ketone, acetophenone, methyl acetophenone, para-methoxy acetophenone, methyl beta-naphthyl ketone, benzyl acetone, benzophenone, para-hydroxyphenyl butanone, celery ketone (3-methyl-5-propyl-2-cyclohexenone), 6-isopropyldecahydro-2-naphthone, dimethyloctenone, Frescomenthe (2-butan-2-yl-cyclohexan-1-one), 4-(1-ethoxyvinyl)-3,3,5,5-tetramethylcyclohexanone, methylheptenone, 2-(2-(4-methyl-3-cyclohexen-1-yl)propyl)cyclopentanone, 1-(p-menthen-6 (2)-yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4 (5H)-indanone, 4-damascol, Dulcinyl (4-(1,3-benzodioxol-5-yl)butan-2-one), hexalone (1-(2,6,6-trimethyl-2-cyclohexen-1-yl)-1,6-heptadien-3-one), Isocyclemone E (2-acetonaphthone-1,2,3,4,5,6,7,8-octahydro-2,3,8,8-tetramethyl), methyl nonyl ketone, methyl cyclocitrone, methyl lavender ketone, Orivone (4-tert-amyl cyclohexanone), 4-tert-butylcyclohexanone, Delphone (2-pentyl-cyclopentanone), muscone (CAS 541-91-3), neobutenone (1-(5,5-dimethyl-1-cyclohexenyl) pent-4-en-1-one), Plicatone (CAS 41724-19-0), Veloutone (2,2,5-trimethyl-5-pentylcyclopentan-1-one), 2,4,4,7-tetramethyl-oct-6-en-3-one and/or tetramerane (6,10-dimethylundecen-2-one). Mixtures of said substances may also be used.

In a further embodiment, at least one fragrance of the multilayer system according to the invention may be an alcohol, preferably selected from 10-undecen-1-ol, 2,6-dimethylheptan-2-ol, 2-methylbutanol, 2-methylpentanol, 2-phenoxyethanol, 2-phenylpropanol, 2-tert-butycyclohexanol, 3,5,5-trimethylcyclohexanol, 3-hexanol, 3-methyl-5-phenyl-pentanol, 3-octanol, 3-phenyl-propanol, 4-heptenol, 4-isopropylcyclohexanol, 4-tert-butycyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, B-terpineol, butyl salicylate, citronellol, cyclohexyl salicylate, decanol, di-hydromyrcenol, dimethylbenzylcarbinol, dimethylheptanol, dimethyloctanol, ethylsalicylate, ethylvanillin, eugenol, farnesol, geraniol, heptanol, hexylsalicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylate, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol. Mixtures of said substances may also be used.

Fragrance compounds of the ester type are e.g., benzyl acetate, phenoxyethyl isobutyrate, p-tert-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate, and jasmacyclate. The ethers include, for example, benzyl ethyl ether and Ambroxan, and the hydrocarbons predominantly include terpenes, such as limonene and pinene. However, mixtures of different odorants are preferably used which together produce an appealing fragrance note.

In a further embodiment, at least one fragrance of the multilayer system according to the invention may be an essential oil, such as angelica root oil, aniseed oil, arnica blossom oil, basil oil, bay oil, champaca blossom oil, citrus oil, abies alba oil, abies alba cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, labdanum oil, lavender oil, lemon grass oil, lime blossom oil, lime oil, mandarin oil, melissa oil, mint oil, musk seed oil, myrrh oil, clove oil, neroli oil, niaouli oil, olibanum oil, orange blossom oil, orange peel oil, oregano oil, palmarosa oil, patchouli oil, balsam Peru oil, petitgrain oil, pepper oil, peppermint oil, allspice oil, pine oil, rose oil, rosemary oil, sage oil, sandalwood oil, celery oil, spike lavender oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil, and ambrettolide, Ambroxan, alpha-amylcinnamaldehyde, anethole, anisaldehyde, anise alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, alpha-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmine, camphor, carvacrol, carvone, p-cresol methyl ether, coumarin, p-methoxyacetophenone, methyl n-amyl ketone, methylanthranilic acid methyl ester, p-methylacetophenone, methylchavicol, p-methylquinoline, methyl beta-naphthyl ketone, methyl n-nonylacetaldehyde, methyl n-nonyl ketone, muscone, beta-naphthol ethyl ether, beta-naphthol methyl ether, nerol, n-nonylaldehyde, nonyl alcohol, n-octylaldehyde, p-oxy-acetophenone, pentadecanolide, beta-phenethyl alcohol, phenylacetic acid, pulegone, safrole, salicylic acid isoamyl ester, salicylic acid methyl ester, salicylic acid hexyl ester, salicylic acid cyclohexyl ester, santalol, skatole, terpineol, thyme, thymol, gamma-undecalactone, vanillin, veratraldehyde, cinnamaldehyde, cinnamyl alcohol, cinnamic acid, cinnamic acid ethyl ester, cinnamic acid benzyl ester, diphenyl oxide, limonene, linalool, linalyl acetate and propionate, melusate, menthol, menthone, methyl-n-heptenone, pinene, phenylacetaldehyde, terpinyl acetate, citral and/or citronellal. Mixtures of said substances may also be used.

In preferred embodiments, the at least one perfume composition in the composition of the first layer and/or the composition of the second layer is contained in an amount of 0.001 to 30 wt. %, preferably 0.01 to 20 wt. %, more preferably 0.1 to 10 wt. %, even more preferably 0.5 to 7 wt. %, even more preferably 1 to 5 wt. %, in particular 2 to 4 wt. %, based on the total weight of the corresponding composition.

D-limonene, for example, can be contained as a perfume component. In a particularly preferred embodiment, the mixture contains tenacious fragrances, in particular ethereal oils (also referred to as essential oils). For example pine, citrus, jasmine, patchouli, rose, or ylang-ylang oil can be used as said oils within the meaning of the invention. Clary sage oil, chamomile oil, lavender oil, clove oil, lemon balm oil, mint oil, cinnamon leaf oil, lime blossom oil, juniper berry oil, vetiver oil, olibanum oil, galbanum oil, and labdanum oil, as well as orange blossom oil, neroli oil, orange peel oil, and sandalwood oil are also suitable. However, other tenacious fragrances, such as the higher-boiling or solid fragrances of natural or synthetic origin, or also more volatile fragrances, in particular the lower-boiling fragrances of natural or synthetic origin, which can be used alone or in mixtures, can advantageously be used within the scope of the present invention.

In various embodiments, the at least two layers have very different fragrances, as a result of which a change in fragrance from, for example, hygienic to floral is produced. If, for example, the first layer is used up, the fragrance changes. In this way, a very distinct olfactory formulation is possible. This means that the consumer receives a means for which it can be precisely defined that a change in fragrance takes place and how this change in fragrance is to look.

The thickness or the volume of the layer preferably determines how long a fragrance impression is to last until it changes. The change in fragrance can take place continuously or preferably suddenly and rapidly.

Preferably, a layer has a thickness of 0.01 to 10 cm, more preferably 0.05 to 5 cm, for example up to 3 cm, even more preferably 0.1 to 1.5 cm, for example 1 cm.

In general, in addition to the thickness of the layer, water solubility or water dispersibility is also the factor which determines the dissolution rate. The individual layers are consumed by dissolution or dispersion in the flush water. Typical products are formulated such that, in the case of a conventional number of flush processes, the product keeps for about 4 weeks before it is completely consumed, i.e., all layers.

According to the invention, the multilayer system comprises at least two layers. However, it can also comprise further layers, for example three or more layers, four or more layers, five or more layers, six or more layers or eight or more layers. In various embodiments in which more than two layers are used, the perfume-containing layers can be separated by an unperfumed barrier layer or a plurality of such barrier layers.

However, multilayer systems having two layers (two-layer system), as described herein, or multilayer systems having three or four layers are particularly preferred. Such multilayer systems contain the first and the second layer as described herein, (all further layers can be constructed similarly to the first or second layer), and a perfume, optionally also a further different perfume, but can alternatively also be perfume free and then, for example, serve the purpose of separating the perfume-containing layers from one another, thereby ensuring as distinct a separation of the different fragrance impressions as possible.

The composition of the at least one further layer preferably comprises at least one perfume composition, wherein the perfume composition comprises
(i) at least one fragrance having a vapor pressure at 25° C.>0.0133 kPa and a ClogP≤2.5; and
(ii) at least one fragrance having a vapor pressure at 25° C.<0.000133 kPa and a ClogP≥4.0; and
(iii) optionally a further fragrance having a vapor pressure at 25° C. of 0.0133 kPa to 0.000133 kPa.

The fragrances can be such as described further above and further can preferably be used in amounts as described further above for the first or second layer. Preferred quantity ranges for fragrances in such a further layer are 0.001 to 30 wt. %, preferably 0.01 to 20 wt. %, more preferably 0.1 to 10 wt. %, even more preferably 0.5 to 7 wt. %, even more preferably 1 to 5 wt. %, in particular 2 to 4 wt. %, in each case relative to the total weight of the layer.

It is preferred that each further layer is also liquid or gel at room temperature.

Another aspect of the invention is an agent comprising a multilayer system according to the invention as described herein.

Particularly preferably, the means according to the invention is a home care product, more preferably a toilet additive, even more preferably an air freshener or a cleaner, even more preferably a toilet cleaner or a toilet freshener, and in particular a (liquid or gel) toilet rimblock, for example in the form of a toilet block, which can also be liquid or gel and is applied in a special holder for this purpose.

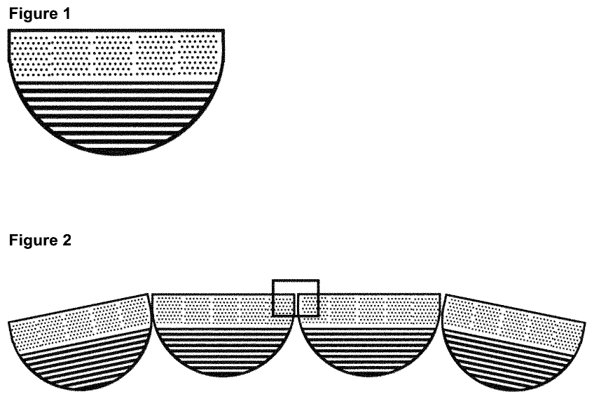

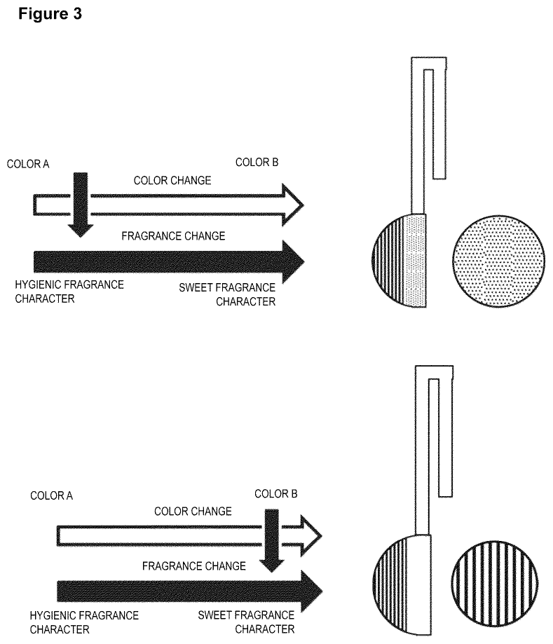

FIG. 1 shows a cross section of a two-layer system which was cast into a corresponding mold in an approximately hemispherical shape. Such a shape can be preferred according to the invention. FIG. 2 shows the cross-section of an arrangement of four such two-layer systems arranged next to one another. FIG. 3 shows a lateral cross-section of such a two-layer system in a holder and the state before and after rinsing away the upper layer, thereby exposing the layer underneath. It is also shown how rinsing away the uppermost layer brings about a change in fragrance.

According to the invention, it is particularly preferred if the compositions of the individual layers are gel fused, i.e., that they are liquefied, in particular by the action of heat, such that they have a gel-like consistency. The compositions are then preferably filled in layers into a container or preferably into a multi-chamber container. Furthermore, the compositions could be filled in layers into an applicator which is suitable for portioning the agent, in particular on the toilet bowl, for example by being stamped or sprayed on.

In addition to the perfume compositions described, the multilayer system according to the invention or the means according to the invention can contain further ingredients. In particular, typical ingredients for air fresheners, toilet blocks or toilet rimblocks are preferred here.

In various embodiments, the composition of the first layer and/or the composition of the second layer and/or the composition of a further layer of the multilayer system according to the invention or of the agent according to the invention additionally contains, in addition to the at least one perfume composition, at least one further constituent, preferably two or more further constituents, wherein the constituents are preferably selected from the group consisting of surfactants, dyes, flush regulators, humectants, bleaching agents, builders, acids, bases, solvents, antimicrobial active ingredients, polymers, salts, thickeners, preservatives, complexing agents, active ingredients for reducing bad odors, perfume boosters, fillers, bleaching agents, corrosion inhibitors, flush regulators, enzymes, microorganisms, active ingredients for biofilm removal, active ingredients for inhibiting limescale deposition, active ingredients for reducing the adhesion of dirt, active ingredients for improving processability and active ingredients for reducing tack. Mixtures of the constituents mentioned can also be included. In addition to the fragrances, typical main constituents of such layers are water and surfactants, in particular nonionic and anionic surfactants. In various embodiments, said ingredients make up at least 70 wt. %, preferably at least 80 wt. %, particularly preferably at least 90 wt. % of the respective layer.

In various embodiments of the invention, the different layers of the multilayer system each have a different color and are visually distinguishable by the use of different dyes.

Preferably, at least one surfactant is contained in the composition of the first layer and/or second layer and/or further layers. This is selected from the group of anionic surfactants, non-ionic surfactants, amphoteric or zwitterionic surfactants, cationic surfactants and mixtures thereof. At least one anionic surfactant, particularly preferably at least one anionic and at least one non-ionic surfactant, is preferably contained.

The multilayer system according to the invention, or at least a composition thereof, preferably contains the at least one surfactant in an amount of 10 to 80 wt. %, preferably 20 to 60 wt. %, particularly preferably 25 to 55 wt. %.

In the scope of the present invention, unless otherwise stated, fatty acids or fatty alcohols or the derivatives thereof represent branched or unbranched carboxylic acids or alcohols or the derivatives thereof preferably having 6 to 22 carbon atoms, in particular 8 to 20 carbon atoms, particularly preferably 10 to 18 carbon atoms, most preferably 12 to 16 carbon atoms, for example 12 to 14 carbon atoms. The former are particularly preferred for ecological reasons on account of the vegetable basis thereof, based on sustainable raw materials, but the teaching according to the invention is not restricted thereto. In particular, the oxo alcohols and the derivatives thereof which are obtained, for example, according to Roelen's oxo synthesis and which preferably comprise 7 to 19 carbon atoms, in particular 9 to 19 carbon atoms, particularly preferably 9 to 17 carbon atoms, most preferably 11 to 15 carbon atoms, for example 9 to 11, 12 to 15 or 13 to 15 carbon atoms, can be used accordingly.

Furthermore, the compositions can contain at least one alkylbenzene sulfonate and/or at least one olefin sulfonate. In addition, further surfactants can be contained, in particular from the group of anionic and/or non-ionic surfactants.

Aliphatic sulfates, such as fatty alcohol sulfates, fatty alcohol ether sulfates, dialkyl ether sulfates, monoglyceride sulfates, and aliphatic sulfonates, such as alkane sulfonates, ether sulfonates, n-alkyl ether sulfonates, ester sulfonates and lignosulfonates, can be in the multilayer system according to the invention as further anionic surfactants. Likewise, fatty acid cyanamides, sulfosuccinates (sulfosuccinic acid esters), in particular sulfosuccinic acid mono-and di-C₈-C₁₈ alkyl esters, sulfosuccinamates, sulfosuccinamides, fatty acid isethionates, acylamino alkane sulfonates (fatty acid taurides), fatty acid sarcosinates, ether carboxylic acids and alkyl (ether) phosphates, and α-sulfo fatty acid salts, acylglutamates, monoglyceride disulfates and alkyl ethers of glycerol disulfate can also be used within the scope of the present invention.

Fatty alcohol sulfates and/or fatty alcohol ether sulfates are preferred within the scope of the present invention. Fatty alcohol sulfates are products of sulfation reactions on corresponding alcohols, while fatty alcohol ether sulfates are products of sulfation reactions on alkoxylated alcohols. A person skilled in the art generally understands alkoxylated alcohols to be the reaction products of alkylene oxide, preferably ethylene oxide, with alcohols, preferably with longer-chain alcohols within the meaning of the present invention. In general, a complex mixture of addition products of different degrees of ethoxylation is created from n moles of ethylene oxide and one mole of alcohol, depending on the reaction conditions. Another embodiment of the alkoxylation consists in using mixtures of alkylene oxides, preferably the mixture of ethylene oxide and propylene oxide. The sulfates of low-ethoxylated fatty alcohols having 1 to 4 ethylene oxide units (EO), in particular 1 to 2 EO, e.g., 1.3EO, are preferred fatty alcohol ether sulfates.

The anionic surfactants are preferably used as sodium salts, but can also be contained as other alkali or alkaline-earth metal salts, for example magnesium salts, and in the form of ammonium salts or mono-, di-, tri-or tetraalkylammonium salts, and in the case of the sulfonates, also in the form of their corresponding acids, e.g., dodecylbenzenesulfonic acid.

In various embodiments, the composition contains at least one alkylbenzene sulfonic acid, preferably in the form of its sodium salt, in an amount of approximately 10 to 30 wt. %, preferably approximately 20 to 25 wt. %, in each case based on the total weight of said composition.

Non-ionic surfactants within the scope of the invention can be alkoxylates such as polyglycol ethers, fatty alcohol polyglycol ethers, alkylphenol polyglycol ethers, end-capped polyglycol ethers, mixed ethers and hydroxy mixed ethers and fatty acid polyglycol esters. Ethylene oxide-propylene oxide block polymers, fatty acid alkanolamides and fatty acid polyglycol ethers can also be used. A further significant class of non-ionic surfactants that can be used according to the invention are polyol surfactants and here, in particular, glycol surfactants such as alkyl polyglycosides and fatty acid glucamides. Alkyl polyglycosides, and in particular fatty alcohol alkoxylates (fatty alcohol polyglycol ethers) are particularly preferred.

Preferred fatty alcohol alkoxylates are ethylene oxide (EO) and/or propylene oxide (PO) alkoxylated, unbranched or branched, saturated or unsaturated Cs-22 alcohols having a degree of alkoxylation of up to 30, preferably ethoxylated C12-22 fatty alcohols having a degree of ethoxylation of less than 30, in particular 12 to 28, preferably 20 to 28, particularly preferably 25, e.g., C₁₆₋₁₈ fatty alcohol ethoxylates having 25 EO.

Alkyl polyglycosides are surfactants that can be obtained by reacting sugars and alcohols according to the relevant processes of preparative organic chemistry, the mixture being one of monoalkylated, oligomeric or polymeric sugars, depending on the type of production. The alkyl polyglucosides are preferred alkyl polyglycosides, the alcohol particularly preferably being a long-chain fatty alcohol or a mixture of long-chain fatty alcohols and branched or unbranched Cs to Cis alkyl chains and the degree of oligomerization (DP) of the sugars being between 1 and 10, preferably 1 to 6, in particular 1.1 to 3, most preferably 1.1 to 1.7, for example C₈₋₁₀ alkyl-1.5-glucoside (DP of 1.5).

Fatty alcohol ethoxylates are preferably used in amounts of up to 20 wt. %, particularly preferably 4 to 12 wt. %, more particularly preferably 7 to 9 wt. %. In addition, further non-ionic surfactants, such as fatty acid monoalkanolamides and/or alkyl polyglycosides, can be contained in amounts of up to 10 wt. %.

In addition to the hitherto mentioned types of surfactant, the mixture can also contain cationic surfactants and/or amphoteric or zwitterionic surfactants.

Suitable amphoteric surfactants are, for example, betaines of formula (Rⁱⁱⁱ)(R^{iv})(R^{v})N⁺CH₂COO—, where Rⁱⁱⁱ denotes an alkyl group, which is optionally interrupted by heteroatoms or heteroatom groups, having 8 to 25, preferably 10 to 21, carbon atoms, and where R^{iv} and RY denote identical or different alkyl groups having 1 to 3 carbon atoms, in particular C₁₀-C₁₈ alkyl dimethyl carboxymethyl betaine and C₁₁-C₁₇ alkyl amidopropyl dimethyl carboxymethyl betaine.

Suitable cationic surfactants are, inter alia, the quaternary ammonium compounds of the formula (R^{vi})(R^{vii})(R^{viii})(R^{ix})N⁺X⁻, where R^{vi} to R^{ix} are four identical or different alkyl groups, in particular two long-chain and two short-chain, alkyl groups, and where X− is an anion, in particular a halide ion, e.g., didecyl dimethyl ammonium chloride, alkyl benzyl didecyl ammonium chloride and the mixtures thereof. Quaternary ammonium compounds having an antimicrobial effect are preferred.

In various embodiments, it is preferred if, in addition to at least one perfume composition and at least one surfactant, as defined above, in total no more than 60 wt. % of further ingredients are contained, preferably 0.01 to 60 wt. %, in particular 0.2 to 15 wt. %, in each case based on the total weight of the respective composition.

Particularly preferably, anionic surfactants, such as sodium lauryl ether sulfates, and non-ionic surfactants, such as ethoxylated C16-C18 (fatty) alcohols or ethoxylated C9-C11 (fatty) alcohols, are used. In various embodiments, these are used, for example, in amounts of 0.1 to 60 wt. %, preferably 1 to 50 wt. %, based on the total weight of the composition.

In order to enhance the cleaning performance with respect to lime and urine scale, the composition of the first layer and/or of the second layer and/or of a further optional layer can contain one or more acids and/or salts thereof. The acids are preferably produced from renewable raw materials. Therefore, in particular organic acids, such as formic acid, acetic acid, citric acid, glycolic acid, lactic acid, succinic acid, adipic acid, malic acid, tartaric acid and gluconic acid, and mixtures thereof, are suitable as acids. In addition, however, the inorganic acids hydrochloric acid, sulfuric acid, phosphoric acid and nitric acid, or also sulfamic acid or mixtures thereof, can also be used. The acids and/or salts thereof selected from the group comprising citric acid, lactic acid, formic acid, the salts thereof, and mixtures thereof are particularly preferred. Said acids and/or salts are used in amounts of 0.01 to 10 wt. %, particularly preferably 0.2 to 5 wt. %.

In addition, inorganic salts can be contained in the composition of one or more of the layers, preferably alkaline metal or alkaline earth metal salts, in particular carbonates, sulfates, halides or phosphates, and mixtures thereof. Particularly preferably, sodium sulfate and/or sodium carbonate are used. Sodium sulfate can be contained in an amount of up to 60 wt. %, preferably 0.01 to 60 wt. %, particularly preferably 20 to 60 wt. %, in particular 35 to 55 wt. %. Sodium carbonate and further salts can be contained in an amount of up to 30 wt. %, preferably up to 10 wt. %, particularly preferably up to 5 wt. %.

In addition, alkalis can be contained. Bases from the group of the alkali and alkaline earth metal hydroxides and carbonates, in particular sodium carbonate or sodium hydroxide, are preferably used as bases. In addition, however, ammonia and/or alkanolamines having up to 9 C atoms in the molecule, preferably ethanolamines, in particular monoethanolamine, can also be used.

Disinfection and sanitation are a particular form of cleaning. In various embodiments of the invention, the composition of one layer or a plurality of layers can therefore contain one or more antimicrobial active ingredients, preferably in an amount of up to 40 wt. %, preferably 0.01 to 25 wt. %, preferably 0.1 to 5 wt. %, in particular 0.1 to 3.5 wt. %, particularly preferably 0.5 to 3 wt. %, in each case based on the total weight of the respective composition.

The terms “disinfection”, “sanitation”, “antimicrobial effect” and “antimicrobial active ingredient” have the conventional meaning thereof within the scope of the teaching according to the invention. While disinfection, in the narrower sense of medical practice, means killing-theoretically all-infectious germs, sanitation is to be understood as eliminating, as far as possible, all germs, including saprophytic germs that are usually harmless to humans. In this case, the extent of the disinfection or sanitation depends on the antimicrobial effect of the agent used, which effect reduces as the content of antimicrobial active ingredient decreases or as the agent to be used becomes increasingly diluted.

For example, antimicrobial active ingredients from the groups of the alcohols, aldehydes, antimicrobial acids and the salts thereof, carboxylic acid esters, acid amides, phenols, phenol derivatives, diphenyls, diphenyl alkanes, urea derivatives, oxygen and nitrogen acetals and methylals, benzamidines, isothiazoles and the derivatives thereof, such as isothiazolins and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl-butyl-carbamate, iodine, iodophors, compounds which release active chlorine, and peroxides are suitable according to the invention. Preferred antimicrobial active ingredients are preferably selected from the group comprising ethanol, n-propanol, i-propanol, 1,3-butanediol, phenoxyethanol, 1,2-propylene glycol, glycerol, undecylenic acid, citric acid, lactic acid, benzoic acid, salicylic acid, thymol, 2-benzyl-4-chlorophenol, 2,2′-methylene-bis-(6-bromo-4-chlorophenol), 2,4,4′-trichloro-2′-hydroxydiphenyl ether, N-(4-chlorophenyl)-N′-(3,4-dichlorophenyl)-urea, N,N′-(1, 10-decandiyldi-1-pyridinyl-4-ylidene)-bis-(1-octanamine)-dichloride, N,N′-bis-(4-chlorophenyl)-3,12-diimino-2,4,11,13-tetraazatetradecandiimidamide, antimicrobial quaternary surface-active compounds, guanidines and sodium dichloroisocyanurate (DCI, 1,3-dichloro-5H-1,3,5-triazine-2,4,6-trione sodium salt). Preferred antimicrobially acting surface-active quaternary compounds contain an ammonium, sulfonium, phosphonium, iodonium or arsonium group. Furthermore, antimicrobially effective ethereal oils can also be used which simultaneously fragrance the detergent. Particularly preferred antimicrobial active ingredients are, however, selected from the group comprising salicylic acid, quaternary surfactants, in particular benzalkonium chloride, peroxo compounds, in particular sodium percarbonate, phthalimidoperoxyhexanoic acid or hydrogen peroxide, alkali metal hypochlorite, trichloroisocyanuric acid, sodium dichloroisocyanurate and mixtures thereof. Sodium dichloroisocyanurate is very particularly preferred.

Preservatives can also be contained. The substances mentioned under the antimicrobial active ingredients can substantially be used as preservatives of this kind.

Complexing agents (INCI chelating agents), also referred to as sequestering agents, are ingredients which allow metal ions to form complexes and to become inactive in order to prevent disadvantageous effects of said ions on the stability or the appearance of the agent, for example cloudiness. It is important to complex the calcium and magnesium ions of the water hardness, which ions are incompatible with many ingredients. However, complexing ions of heavy metals, such as iron or copper, delays the oxidative decomposition of the finished agents. In addition, the complexing agents assist with the cleaning effect.

The following complexing agents designated according to INCI are suitable, for example, without being limited thereto:

Aminotrimethylene phosphonic acid, beta-alanine diacetic acid, calcium disodium EDTA, citric acid, cyclodextrin, cyclohexanediamine tetraacetic acid, diammonium citrate, diammonium EDTA, diethylenetriamine pentamethylene phosphonic acid, dipotassium EDTA, disodium azacycloheptane diphosphonate, disodium EDTA, disodium pyrophosphate, EDTA, etidronic acid, galactaric acid, gluconic acid, glucuronic acid, HEDTA, hydroxypropyl cyclodextrin, methyl cyclodextrin, pentapotassium triphosphate, pentasodium aminotrimethylene phosphonate, pentasodium ethylenediamine tetramethylene phosphonate, pentasodium pentetate, pentasodium triphosphate, pentetic acid, phytic acid, potassium citrate, potassium EDTMP, potassium gluconate, potassium polyphosphate, potassium trisphosphonomethylamine oxide, ribonic acid, sodium chitosan methylene phosphonate, sodium citrate, sodium diethylenetriamine pentamethylene phosphonate, sodium dihydroxyethylglycinate, sodium EDTMP, sodium gluceptate, sodium gluconate, sodium glycereth-1 polyphosphate, sodium hexametaphosphate, sodium metaphosphate, sodium metasilicate, sodium phytate, sodium polydimethylglycinophenolsulfonate, sodium trimetaphosphate, TEA-EDTA, TEA-polyphosphate, tetrahydroxyethyl ethylenediamine, tetrahydroxypropyl ethylenediamine, tetrapotassium etidronate, tetrapotassium pyrophosphate, tetrasodium EDTA, tetrasodium etidronate, tetrasodium pyrophosphate, tripotassium EDTA, trisodium dicarboxymethyl alaninate, trisodium EDTA, trisodium HEDTA, trisodium NTA and trisodium phosphate.

Further suitable ingredients, in particular for cleaners or air fresheners, such as toilet rimblocks, are polymers. Said polymers can, for example, be used to reduce calcification and the tendency to become resoiled (e.g. soil-repellent polymers). Acrylic polymers, such as those which are commercially available from the company Rhodia under the trade name Mirapol, are preferred polymers.

The composition of the first layer, the composition of the second layer and/or the composition of a possible further layer can contain aqueous and/or organic solvents. In particular, water, dipropylene glycol or paraffin can be used as preferred liquids.

One or more dyes (INCI colorants) can be contained as further ingredients. Water-soluble and oil-soluble dyes can be used as dyes, it being important that the compatibility with further ingredients, for example bleaching agents, is taken into account and that the dye used should not significantly affect the WC ceramics, even after long-term use. It can preferably be a water-soluble dye which colors the flush water. The flush water colored with this dye remains, due to the after-running after the actual flushing process has ended, in sufficient concentration in the toilet sump, i.e., in the rest of the flush water which remains in the toilet bowl in order to give it a color. The dyes are preferably contained in an amount of from 0.0001 to 5 wt. %, in particular 0.0005 to 0.05 wt. %, particularly preferably 0.001 to 0.01 wt. %.

It is particularly preferred that the composition of the first layer and/or the composition of the second layer and/or a composition of an optional further layer comprise, in addition to the perfume composition, at least one dye.

By incorporating the dye compositions into the perfume compositions, a color change of the multilayer system can be produced.

In addition, active ingredients for preventing or reducing bad odors, e.g. malodor repellents, can be used. These are usually substances which adsorb, chelate, oxidize or form inclusion compounds with the volatile substances which produce the bad odor such that they become inactivated in terms of odor (so-called deodorants), or they are fragrances which have their own odor to mask the unpleasant bad odor and neutralize it in this way (so-called odor improvers).

In the multilayer systems produced according to the invention, optionally water-soluble and/or water-insoluble builders can be contained in one or more layers. Water-soluble builders are preferred since they are generally less likely to form insoluble residues on hard surfaces. Conventional builders which may be added within the scope of the invention are low-molecular-weight polycarboxylic acids and the salts thereof, homopolymeric and copolymeric polycarboxylic acids and the salts thereof, citric acid and the salts thereof, carbonates, phosphates and silicates. The category of water-insoluble builders includes zeolites, which may also be used, and mixtures of the aforementioned builders.

According to the invention, bleaching agents can furthermore be used. Suitable bleaching agents include peroxo compounds, in particular peroxides, peracids, percarbonates and/or perborates; sodium percarbonate, phthalimidoperoxyhexanoic acid or hydrogen peroxide are particularly preferred. In contrast, alkali metal hypochlorites, such as sodium hypochlorite, are less suitable for use with acid-formulated detergents because they release poisonous chlorine gas vapors, but they can be used in the case of alkaline cleaning agents, however. Trichloroisocyanuric acid and in particular sodium dichloroisocyanurate are also suitable. In some circumstances, a bleach activator may also be required in addition to the bleaching agent.

Suitable corrosion inhibitors (INCI corrosion inhibitors) are, for example, without being limited thereto, the following substances named in accordance with INCI: cyclohexylamine, diammonium phosphate, dilithium oxalate, dimethylamino methylpropanol, dipotassium oxalate, dipotassium phosphate, disodium phosphate, disodium pyrophosphate, disodium tetrapropenyl succinate, hexoxyethyl diethylammonium, phosphate, nitromethane, potassium silicate, sodium aluminate, sodium hexametaphosphate, sodium metasilicate, sodium molybdate, sodium nitrite, sodium oxalate, sodium silicate, stearamidopropyl dimethicone, tetrapotassium pyrophosphate, tetrasodium pyrophosphate, and triisopropanolamine.

The substances referred to as rinsing regulators are primarily used to control the consumption of the agent during use such that the intended service life is met. Solid long-chain fatty acids, such as stearic acid, but also salts of such fatty acids, fatty acid ethanolamides, such as coconut fatty acid monoethanolamide, or solid polyethylene glycols, such as those having molecular weights of between 10,000 and 50,000, are preferably suitable as regulators.

Further suitable constituents which can be used in the multilayer system according to the invention, preferably a cleaner or air freshener, in particular toilet rimblocks, are enzymes, preferably proteases, lipases, amylases, hydrolases, and/or cellulases. They can be added in any form established according to the prior art. These include solutions of the enzymes, advantageously as concentrated as possible, low in water and/or mixed with stabilizers. Alternatively the enzymes can also be encapsulated, for example by spray-drying or extruding the enzyme solution together with a preferably natural polymer or in the form of capsules, for example those in which the enzymes are enclosed in a solidified gel, or in the form of the core-shell type in which an enzyme-containing core is coated with a water-, air-, and/or chemical-impermeable protective layer. Further active ingredients, for example, stabilizers, emulsifiers, pigments, bleaches or dyes can additionally be applied in overlaid layers. Advantageously, such granules are low in dust, for example due to the application of polymeric film formers, and are stable in storage due to the coating.

Furthermore, enzyme stabilizers can be present in enzyme-containing systems or agents in order to protect an enzyme contained in a system or means according to the invention from damage, for example inactivation, denaturation, or decomposition caused, e.g., by physical influences, oxidation, or proteolytic cleavage. Suitable in particular as enzyme stabilizers, each as a function of the enzyme used, are: benzamidine hydrochloride, borax, boric acid, boronic acid or the salts or esters thereof, in particular derivatives having aromatic groups, such as substituted phenylboronic acids or the salts or esters thereof; peptide aldehydes (oligopeptides having a reduced C-terminus), amino alcohols such as mono-, di-, triethanol-and-propanolamine and the mixtures thereof, aliphatic carboxylic acids up to C12, such as succinic acid, other dicarboxylic acids or salts of the mentioned acids; end-capped fatty acid amide alkoxylates; low aliphatic alcohols and in particular polyols, for example glycerol, ethylene glycol, propylene glycol or sorbitol; and reducing agents and antioxidants such as sodium sulfite and reducing sugars. Further suitable stabilizers are known from the prior art. Preferably, combinations of stabilizers are used, for example the combination of polyols, boric acid and/or borax, the combination of boric acid or borate, reducing salts and succinic acid or other dicarboxylic acids, or the combination of boric acid or borate with polyols or polyamino compounds and with reducing salts.

It is particularly preferred that the composition of the first layer and/or the composition of the second layer and/or the composition of a further layer in addition to the at least one perfume composition further comprise at least one further constituent, preferably two or more further constituents, wherein the constituents are preferably selected from the group consisting of surfactants, in particular sodium lauryl ether sulfate, ethoxylated C16-C18 (fatty) alcohols, and ethoxylated C9-C11 (fatty) alcohols, humectants, for example propane-1,2,3-triol, dyes, emulsifying aids, preservatives, complexing agents, solvents, acids, in particular for limescale prevention, polymers, further fragrances, or mixtures thereof.

In a further aspect, the invention relates to a method for fragrancing the toilet, wherein a multilayer system according to the invention or a means according to the invention is used in at least one method step. In this case, it is particularly preferred that the fragrance impression change over time. This is achieved in particular by the fact that a layer of the multilayer system or means is consumed over time and then a second layer, which has a different fragrance, comes into contact with the flush water and releases its fragrance to the surroundings.

The fragrancing of the toilet, preferably also includes the fragrancing of the room in which the toilet is located. In particular, the processed fragrances are released to the ambient air, wherein it is preferred that the fragrances stay in the air for as long as possible and can thus be discerned.

In addition to fragrancing the toilet, the multilayer system according to the invention can preferably also be used for cleaning and/or disinfecting the toilet by using suitable ingredients, as has already been described above. Different active ingredients can be incorporated into different layers and released at different times depending on the degree of rinsing.

Where a toilet is mentioned in the context of this invention, a modern flush toilet is preferably meant.

A further aspect of the invention is a method for producing a multilayer system according to the invention, as described herein, wherein the composition of the first layer and/or the composition of the second layer are preferably melted at polyamine least 50° C., more preferably at least 60° C., even more preferably at least 65° C., even more preferably at least 70° C., and/or preferably at a maximum of 150° C., more preferably at a maximum of 120° C., even more preferably at a maximum of 100° C., in particular at a maximum of 90° C., for example at 50 to 150° C., 60 to 100° C., for example at 50 to 150° C., 60 to 100° C., or 70-90° C. and then cast in layers.

The compositions of the individual layers can, for example, be provided in an applicator which facilitates portioning of the multilayer system. The multilayer system according to the invention can thereby, for example, be stamped or sprayed onto the ceramic toilet surface. Another delivery format is the filling of the multilayer system according to the invention in (plastic) containers, for example, basket-like containers. These containers are usually in the form of hemispheres. The individual layers of the multilayer system according to the invention must be poured in here alternately. This process could be repeated as often as desired in order to build up two, three or more multilayer systems, for example. Through skillful formulation of the perfume compositions in the different layers, a change of fragrance can be produced both before, during and after the flush phase. Furthermore, it is conceivable that the multilayer systems in the individual containers of the multi-chamber container differ in order to bring about a particularly complex fragrance or color experience or a specific cleaning performance.

Finally, the invention relates to the use of the multilayer system according to the invention or of the agent according to the invention for fragrancing and optionally for cleaning and/or disinfecting a toilet, in particular a flush toilet, wherein the fragrance impression preferably changes over time, as has already been described above.

In particularly preferred embodiments, both the fragrance impression and the color impression change over time. In addition to the perfume compositions of the individual layers of the multilayer system according to the invention, dyes or dye compositions are also incorporated in one layer, several layers or all layers.

All aspects, objects and embodiments described for the multilayer system according to the invention are also applicable to the further subjects of the invention. Therefore, reference is expressly made at this point to the disclosure at the appropriate point with the note that this disclosure also applies to the above-described agents, uses and methods according to the invention and vice versa.

### EXAMPLES

An exemplary multilayer system comprises
(a) a first layer comprising at least one perfume composition, wherein the perfume composition comprises
   (i) 0.01 wt. % to 50 wt. % of at least one fragrance having a vapor pressure >0.0133 kPa and a ClogP≤2.5; and
   (ii) less than 20 wt. % of at least one fragrance having a vapor pressure at 25° C.<0.000133 kPa and a ClogP≥4.0; and
(b) a second layer comprising at least one perfume composition, wherein the perfume composition comprises
   (i) 0.01 wt. % to 20 wt. % of at least one fragrance having a vapor pressure >0.0133 kPa and a ClogP≤2.5; and
   (ii) more than 30 wt. % of at least one fragrance having a vapor pressure at 25° C.<0.000133 kPa and a ClogP≥4.0;

This system offers the consumer a fragrance experience that changes over the period of use.

By incorporating various dye and perfume compositions into the first and/or the second layer and/or further layers, various polysensory discernment sequences are produced; subtractive color mixing and segregation of the layers, by transmission, can produce a color change of the product.

By fragrancing differently, e. g., hygienic signature scent (aromatic, aldehyde) for the first two weeks, then a change to a refreshing, flora composition (floral, fougere), it is possible for the olfactorily formulation to be distinct.

This application contains images that will be described briefly below:

FIG. 1 shows a hemispherical plastic container comprising an exemplary multilayer system, in particular a two-layer system.

FIG. 2 shows an exemplary multi-chamber system consisting of individual hemispherical plastic containers and comprising an exemplary multilayer system, in particular a two-layer system.

FIG. 3 shows the change in the fragrance impression and the color impression of a multilayer system according to the invention over time, wherein in this exemplary illustration, the fragrance first makes a hygienic impression and then changes to a pleasant, for example, floral fragrance. Likewise, the color of the product changes over time, for example green (color impression in the layering of blue and yellow layers) to yellow (if the blue layer is used up).

1. A multilayer system comprising:
a first layer comprising at least one first perfume composition, wherein the at least one first perfume composition comprises:
at least one first fragrance having a vapor pressure at 25 C that is greater than 0.0133 kPa and a ClogP that is less than or equal 2.5; and
at least one second fragrance having a vapor pressure at 25 C that is less than 0.000133 kPa and a ClogP that is greater than or equal to 4.0; and
a second layer comprising at least one second perfume composition, wherein the at least one second perfume composition comprises:
at least one third fragrance having a vapor pressure at 25 C that is greater than 0.0133 kPa and a ClogP that is less than or equal to 2.5; and
at least one fourth fragrance having a vapor pressure at 25 C that is less than 0.000133 kPa and a ClogP that is greater than or equal to 4.0.

2. The multilayer system of claim 1, wherein:
the at least one first fragrance is in an amount of 0.001 to 70 wt. % of the at least one first perfume composition,
the at least one second fragrance is in an amount of less than 30 wt. %, of the at least one first perfume composition, of the first layer; and/or
the at least one third fragrance is in an amount of 0.001 to 40 wt. % of the at least one second perfume composition, or
the at least one fourth fragrance is in an amount of more than 30 wt. % of the at least one second perfume composition.

3. The multilayer system of claim 2, wherein:
the at least one first fragrance is in an amount of 0.01 wt. % to 30 wt. % of the at least one first perfume composition,
the at least one second fragrance is in an amount of less than 15 wt. % of the at least one first perfume composition,
the at least one third fragrance is in an amount of 0.01 wt. % to 15 wt. % of the at least one second perfume composition, or
the at least one fourth fragrance is in an amount of more than 55 wt. % of the at least one second perfume composition.

4. The multilayer system of claim 1, wherein the at least one first perfume composition or the at least one second perfume composition comprises at least one further fragrance having a vapor pressure at 25 C from 0.0133 to 0.000133 kPa.

5. The multilayer system of claim 1, wherein;
the at least one first perfume composition is in an amount from 0.01 to 20 wt. % of the first layer, and
the at least one second perfume composition is in an amount from 0.01 to 20 wt. % of the second layer.

6. The multilayer system of claim 1, wherein the at least one first perfume composition and/or the at least one second perfume composition further comprises at least one further constituent selected from the group consisting of surfactants, ethoxylated C16-C18 alcohols, ethoxylated C9-C11 alcohols, humectants, dyes, emulsifying aids, preservatives, complexing agents, acids, solvents, polymers, other fragrances, and mixtures thereof.

7. The multilayer system of claim 1, wherein the multilayer system comprises at least one further layer.

8. The multilayer system of claim 1, wherein the first layer and/or the second layer is a liquid or a gel at room temperature.

9. A cleaner or an air freshener comprising the multilayer system of claim 1.

10. A method for fragrancing, the method comprising applying the multilayer system of claim 1, wherein the fragrance impression changes over time.

11. A method for producing the multilayer system of claim 1, the method comprising:
melting the at least one first perfume composition of the first layer and the at least one second perfume composition of the second layer at at least 50 C; and
casting the first layer and the second layer.

12. Using the multilayer system of claim 1 for fragrancing, wherein the fragrance impression changes over time.

13. The multilayer system of claim 1, wherein the at least one first perfume composition and/or the at least one second perfume composition further comprises a dye.

14. The multilayer system of claim 4, wherein the at least one further fragrance has a ClogP from 2 to 4.

15. The multilayer system of claim 5, wherein:
the at least one first perfume composition is in an amount from 2 to 4 wt. % of the first layer, and
the at least one second perfume composition is in an amount from 2 to 4 wt. % of the second layer.

16. The multilayer system of claim 6, wherein:
the surfactants comprise sodium lauryl ether sulfate, or
the humectants comprise propane-1,3-triol.

17. The multilayer system of claim 7, wherein the multilayer system comprises at least seven layers.

18. The cleaner or the air freshener of claim 9, wherein the cleaner or the air freshener is a toilet cleaner or a toilet freshener.

19. The method for fragrancing of claim 10, wherein applying the multilayer system of claim 1 comprises applying the multilayer system of claim 1 to a toilet.

20. The method of claim 11, wherein the at least one first perfume composition of the first layer and the at least one second perfume composition of the second layer are melted at 70-90° C.
